(19) United States
(12) Patent Application Publication
(10) Pub. No.: US 2009/0096821 A1
(43) Pub. Date: Apr. 16, 2009

(54) LIQUID DROPLET DRYING METHOD OF LIQUID DROPLET DISCHARGING APPARATUS AND LIQUID DROPLET DISCHARGING APPARATUS

(75) Inventors: Yoshikazu HAMA, Okaya (JP); Hirotsuna MIURA, Fujimi (JP); Hiroki MASUZAWA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/235,935

(22) Filed: Sep. 23, 2008

(30) Foreign Application Priority Data
Oct. 11, 2007 (JP) 2007-265273

(51) Int. Cl. B41J 29/38

(52) U.S. Cl. 347/9

(57) ABSTRACT

A liquid droplet drying method of a liquid droplet discharging apparatus includes discharging liquid droplets from respective nozzles of a discharging head onto a substrate, the droplets being discharged from the nozzles at timings different from each other; and drying the liquid droplets by irradiating a laser beam to the liquid droplets vertically to a discharging direction of the liquid droplets while the droplets are flying toward the substrate, the laser beam being irradiated in a layout direction of the nozzles of the discharging head.

### BACKGROUND

1. Technical Field

The present invention relates to a liquid droplet drying method of a liquid droplet discharging apparatus and to a liquid droplet discharging apparatus.

2. Related Art

Conventionally, there has been known a method for forming a linear pattern on a substrate by using a liquid droplet discharging apparatus. In the method, the discharging apparatus discharges droplets of a liquid that contains a pattern material on the substrate.

In general, the discharging apparatus includes a substrate mounted on a stage, a liquid droplet discharging head that discharges droplets of a functional liquid containing a pattern material on the substrate, and a mechanism that allows two-dimensional relative motion between the substrate (the stage) and the discharging head. The apparatus lays out each of the droplets discharged from the head in an arbitrary position on a substrate surface. In this case, the droplets sequentially discharged on the surface are laid out in discharging order thereon in such a manner that spreading ranges of the droplets overlap with each other. As a result, without any gap between the droplets, there can be formed a linear pattern covered with the functional liquid on the substrate surface.

In terms of productivity and formation of a highly precise pattern, preferably, the droplets discharged on the substrate are immediately dried.

Accordingly, various methods are proposed. For example, there is a method for immediately drying droplets discharged on a substrate by preheating of the substrate. In another method, a flow of air is introduced between a discharging head and a substrate (a platen gap) to allow moisture of liquid droplets landed on the substrate to escape, thereby accelerating drying of the droplets (e.g. JP-A-1996-1924, JP-A-1996-281923, JP-A-2002-127398, and JP-A-2005-59478).

Furthermore, there has been examined a method in which a laser beam is irradiated on liquid droplets on a substrate or on droplets flying between a discharging head and the substrate to immediately dry the droplets. FIG. 9 is a schematic view showing the droplet drying method using a laser beam. As shown in the drawing, each droplet D is simultaneously discharged from each nozzle formed linearly on a nozzle plate of a discharging head 100, and then is subjected to irradiation of a belt-like beam Le of laser light during its flight. In other words, the belt-like beam Le is irradiated vertically from a Y-axis direction with respect to a direction of a nozzle line (an X-axis direction), whereby the droplets D discharged in a single line and at an equal pitch are simultaneously subjected to the irradiation to be dried.

In the above known methods, however, while the belt-like beam Le is applied to each of the droplets discharged at the equal pitch in the nozzle-line direction (the X-axis direction), the beam Le passing through a space between the droplets D without impinging onto any droplet does not contribute to drying and is useless.

Additionally, a width of the belt-like beam is needed to be equivalent to at least a width of the nozzle line linearly formed in the single line on the nozzle plate. Then, increasing the width of the beam Le up to the width of the nozzle line requires an extremely sophisticated optical design technology.

### SUMMARY

The present invention has been accomplished to solve the above problems. An advantage of the invention is to provide a liquid droplet drying method of a liquid droplet discharging apparatus, in which the method enables drying of the droplets in an air, as well as improvement of laser energy efficiency. Another advantage of the invention is to provide a liquid droplet discharging apparatus for implementing the above method.

A liquid droplet drying method of a liquid droplet discharging apparatus according to a first aspect of the invention includes discharging liquid droplets from respective nozzles of a discharging head onto a substrate, the droplets being discharged from the nozzles at timings different from each other; and drying the liquid droplets by irradiating a laser beam to the liquid droplets vertically to a discharging direction of the liquid droplets while the droplets are flying toward the substrate, the laser beam being irradiated in a layout direction of the nozzles of the discharging head.

In the liquid droplet drying method according to the first aspect, while irradiating the laser beam in the layout direction of the nozzles between a nozzle plate and the substrate, liquid droplets are discharged from the nozzles at timings different from each other. This can ensure that each liquid droplet is subjected to a continuous irradiation of the laser beam, without allowing the laser beam to be intercepted by any other of the droplets. This results in improvement in energy efficiency of the laser beam.

In the liquid droplet drying method according to the first aspect, preferably, among the liquid droplets sequentially discharged from the nozzles, a time difference of discharging timing between a previously discharged droplet and a subsequent droplet is expressed by a formula: Δt>2r/V, in which Δt represents the time difference, r represents a radius of the droplet, and V represents a velocity of the droplet.

In the above liquid droplet drying method, the laser beam toward the subsequent droplet is not intercepted by any other of the droplets.

Additionally, in the liquid droplet drying method according to the first aspect, preferably, an inclined angle of the layout direction of the nozzles of the discharging head with respect to a sub-scanning direction orthogonal to a main scanning direction is expressed by a formula: θ=tan⁻¹(Δy/Dx)=tan⁻¹(Vs×Δt/Dx), in which θ represents the inclined angle; Dx represents a gap between the nozzles; and Vs represents a conveying velocity of the substrate.

The liquid droplet drying method above eliminates a landing deviation of the droplet discharged from each nozzle in the main scanning direction due to the time difference of the discharging timing between any one of the droplets and the subsequent droplet.

A liquid droplet discharging apparatus according to a second aspect of the invention includes a substrate, a discharging head that discharges liquid droplets to the substrate, a nozzle plate with nozzles that is included in the discharging head, and a laser beam outputting unit that irradiates a laser beam to the liquid droplets while the droplets are flying toward the substrate so as to dry the droplets, the laser beam outputting unit being provided on a first side in a layout direction of the nozzles of the head to irradiate the laser beam traversing immediately below the nozzles from the layout direction of the nozzles, between the nozzle plate of the head and the substrate.

In the liquid droplet discharging apparatus according to the second aspect, the laser beam outputting unit is provided on the first side in the layout direction of the nozzles of the discharging head to irradiate the laser beam traversing immediately below the nozzles from the layout direction of the nozzles. Thus, for example, discharging droplets from the respective nozzles at different timings ensures that each of the droplets is subjected to an irradiation of the laser beam, without allowing the laser beam to be intercepted by any other of the droplets. Consequently, energy efficiency of the laser beam can be improved.

Preferably, the liquid droplet discharging apparatus according to the second aspect further includes a drive controlling unit that drive-controls the discharging head to make different the discharging timings of the droplets discharged from the respective nozzles so as to allow the laser beam toward a droplet discharged from any one of the nozzles not to be intercepted by a droplet discharged from any other of the nozzles located in an irradiating direction of the laser beam.

The liquid droplet discharging apparatus above can ensure that each droplet is subjected to irradiation of the laser beam, without allowing the laser beam to be intercepted by any other of the droplets. This results in improvement in energy efficiency of the laser beam.

In the liquid droplet discharging apparatus above, preferably, among the liquid droplets sequentially discharged from the nozzles, a time difference of discharging timing between a previously discharged droplet and a subsequent droplet is expressed by a formula: Δt>2r/V, in which Δt represents the time difference; r represents a radius of the droplet; and V represents a velocity of the droplet, and wherein the drive controlling unit drive-controls the discharging head to discharge the droplets from the respective nozzles in the time difference Δt.

In the liquid droplet discharging apparatus above, the laser beam toward each droplet is not intercepted by any other of the droplets.

In the liquid droplet discharging apparatus above, preferably, the discharging head is laid out in such a manner that an inclined angle of the layout direction of the nozzles of the discharging head with respect to a sub-scanning direction orthogonal to a main scanning direction is expressed by a formula: θ=tan⁻¹(Δy/Dx)=tan⁻¹(Vs×Δt/Dx), in which θ represents the inclined angle; Dx represents a gap between the nozzles; and Vs represents a conveying velocity of the substrate.

The liquid droplet discharging apparatus above eliminates a landing deviation of the droplet discharged from each nozzle in the main scanning direction due to the time difference of the discharging timing between the droplet and a subsequent droplet.

### BRIEF DESCRIPTION OF THE DRAWINGS

The invention will be described with reference to the accompanying drawings, wherein like numbers reference like elements.

FIG. 1 is an entire perspective view of a liquid droplet discharging apparatus employed in a first embodiment of the invention.

FIG. 2 is a perspective view of a liquid droplet discharging head as viewed from a bottom side.

FIG. 3 is an illustration showing a layout of liquid droplet discharging heads provided on a carriage in the first embodiment.

FIG. 4 is a sectional view of a main part of the liquid droplet discharging head.

FIG. 5 is a sectional view taken along line 5-6 of FIG. 3 to show a discharging operation of the liquid droplet discharging head.

FIG. 6 is a schematic diagram illustrating a relationship between a laser beam and respective liquid droplets.

FIG. 7 is a block circuit diagram showing an electrical structure of the liquid droplet discharging apparatus.

FIG. 8 is an illustration showing a layout of liquid droplet discharging heads provided on a carriage in a second embodiment of the invention.

FIG. 9 is a schematic diagram illustrating a relationship between a laser beam and respective liquid droplets in a related art.

### DESCRIPTION OF EXEMPLARY EMBODIMENTS

Hereinafter, embodiments of the invention will be described.

### First Embodiment

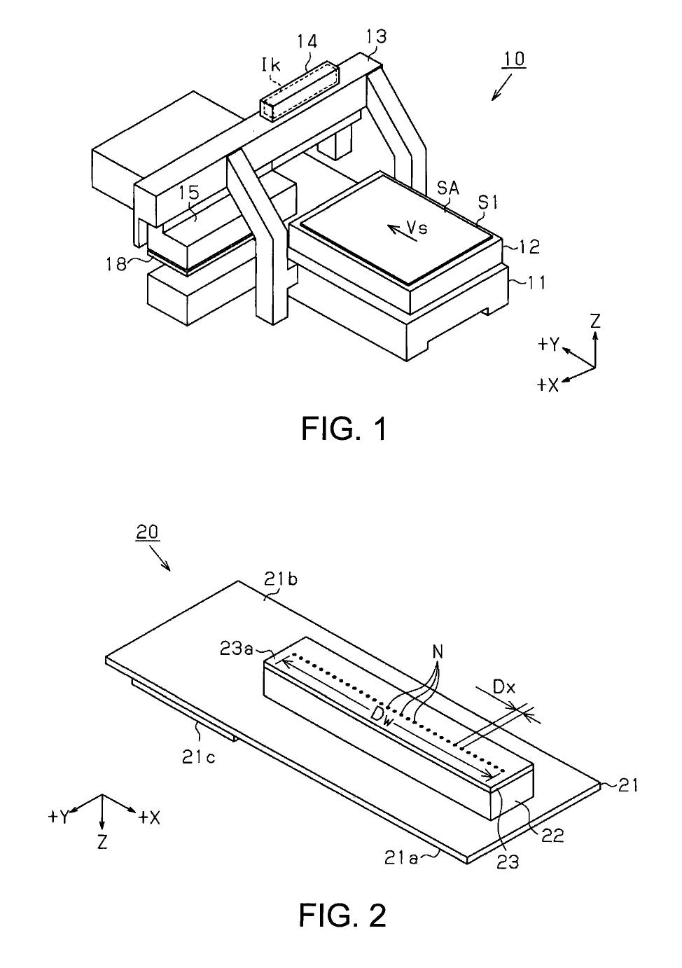

A first embodiment of the invention will be described with FIGS. 1 to 5. FIG. 1 is an entire perspective view of a liquid droplet discharging apparatus 10.

In FIG. 1, the liquid droplet discharging apparatus 10 includes a base 11 extended in a single direction and a stage 12 mounted on the base 11 to have a substrate S1 placed thereon. The stage 12 positionally fixes the substrate S1 thereon in such a manner that a surface of the substrate faces upward, and conveys the substrate S1 in a longitudinal direction of the base 11.

The substrate S1 is composed of any one of various kinds of substrates such as a green sheet, a glass substrate, a silicon substrate, a ceramic substrate, a resin film, and paper.

In the present embodiment, an upper surface of the substrate S1 placed on the stage 12 is referred to as a discharging surface SA. Additionally, a direction in which the substrate S1 is conveyed toward upper left in FIG. 1 is referred to as a +Y direction. A direction orthogonal to the +Y direction and toward lower left is referred to as a +X direction, and a normal line toward the substrate S1 is referred to as a Z direction.

The liquid droplet discharging apparatus 10 also includes a guide member 13 having a gate shape straddling the base 11 and an ink tank 14 disposed on an upper side of the guide member 13. The ink tank 14 stores a predetermined ink Ik and draws the ink out of the tank under a predetermined pressure applied. The ink Ik may be any one of various kinds of ink such as silver ink that contains silver microparticles, indium tin oxide (ITO) ink that contains ITO microparticles, and pigment ink that contains a pigment.

The guide member 13 supports a carriage 15 movably in the +X direction and a direction opposite to the +X direction (a −X direction). On a lower surface of the carriage 15 is disposed a supporting plate 18 in parallel to the stage 12. The supporting plate 18 has a plurality of liquid droplet discharging heads 29 provided thereon.

In the embodiment, operation of conveying the substrate S1 in the +Y direction and a −Y direction is referred to as main scanning, and operation of conveying the carriage 15 in the +X direction and the −X direction is referred to as sub-scanning.

### Liquid Droplet Discharging Head 20

Next will be described the liquid droplet discharging heads 20 provided on the supporting plate 18 disposed on the lower surface of the carriage 15.

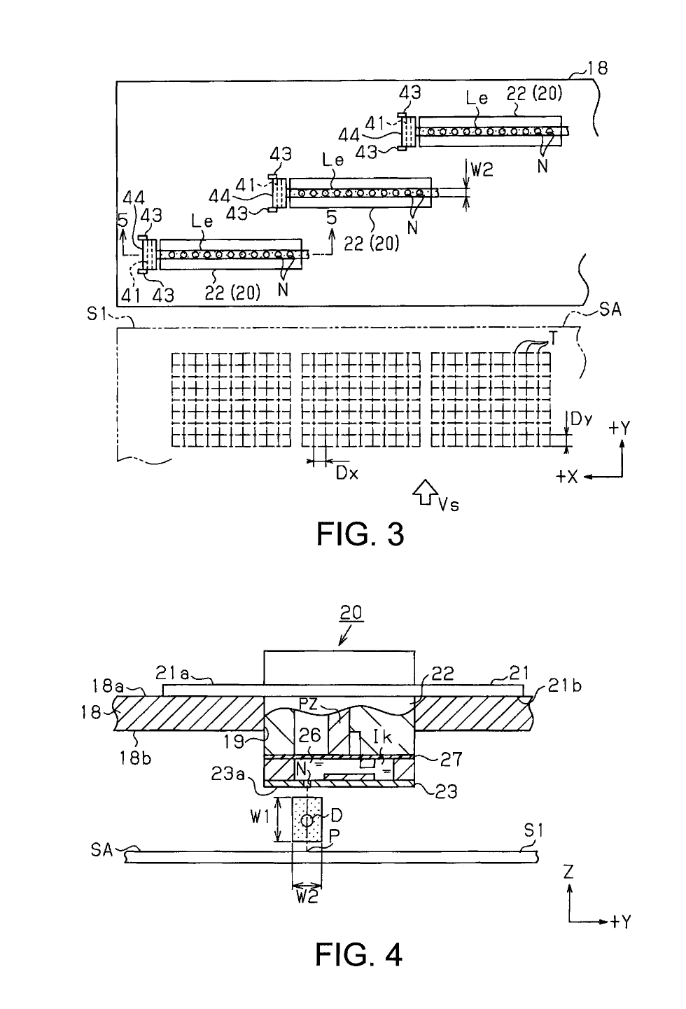

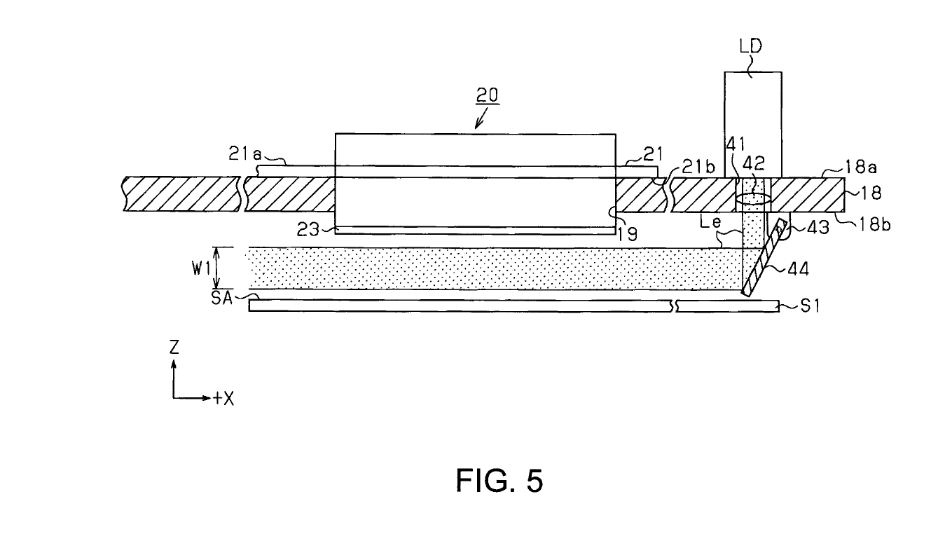

FIG. 2 is a perspective view of one of the liquid droplet discharging heads 20 to be provided on the supporting plate 18, appeared as viewed from the stage 12. FIG. 3 is an illustration showing a layout of the liquid droplet discharging heads 20 appeared as viewed from the stage 12. FIG. 4 is a sectional view of a main part of the discharging head 20, and FIG. 5 is a sectional view of a main part taken along line 5-5 of FIG. 3.

In FIG. 2, the liquid droplet discharging head 20 includes a head substrate 21 fixed to the supporting plate 18 in a manner extending in the +X direction and a discharging head main body 22 fixed to a lower surface 21b of the head substrate 21 in the manner extending in the +X direction as is the head substrate 21.

The head substrate 21 is positionally fixed onto the supporting plate 18. Specifically, as shown in FIGS. 4 and 5, the liquid droplet discharging head 20 allows the discharging head main body 22 to penetrate from an upper surface 18a of the supporting plate 18 through a through-hole 19 formed in the plate 18 so that the main body 22 is protruded from a lower surface 18b of the supporting plate 18. In the state where the discharging head main body 22 is protruded from the lower surface 18b of the supporting plate 18b, the upper surface 18a of the supporting plate 18 is adherently fixed to the head substrate 21 to allow the liquid droplet discharging head 20 to be supportedly fixed to the supporting plate 18. Thereby, the liquid droplet discharging head 20 moves together with the carriage 15 in the +X and the −X directions.

The head substrate 21 has an input terminal 21c provided on an end side of an upper surface 21a of the substrate to output a driving waveform signal input to the input terminal 21c to the discharging head main body 22 fixed to a lower surface 21b of the head substrate 21.

As shown in FIG. 4, the discharging head main body 22 has a nozzle plate 23 on a side of the main body 22 facing the substrate S1. A surface of the nozzle plate 23 facing the substrate S1 is referred to as a nozzle-formed surface 23a. The nozzle-formed surface 23a is located approximately in parallel to the discharging surface SA when the liquid droplet discharging head 20 faces the substrate S1.

As shown in FIG. 2, the nozzle-formed surface 23a has “i” pieces (“i” is an integer equal to or larger than 2) of nozzles N (180 pieces per inch in the embodiment) provided over an entire width of the surface in the +X direction. The respective nozzles N are formed to penetrate through the nozzle plate 23 in the Z direction and arranged at a predetermined pitch in the +X direction. The nozzle plate 23 has at least a single nozzle line composed of the “i” pieces of nozzles N. In the embodiment, the pitch of the nozzles N is referred to as a nozzle pitch Dx. Additionally, a width of the nozzle plate 23 in the +X direction (a 1-inch width) is referred to as a head width Dw.

In FIG. 4, the liquid droplet discharging head 20 includes a cavity 26, a vibrating plate 27, and a piezoelectric element PZ on an upper side of each nozzle. Each of the cavities 26 is connected to the ink tank 14 common to all the cavities to contains the ink Ik supplied from the ink tank 14 to supply the ink to each nozzle N. Each vibrating plate 27 allows a region of the vibrating plate facing the cavity 26 to vibrate in the Z direction so as to increase or reduce a capacity of the cavity 26, thereby vibrating a meniscus of the nozzle N. Each of the piezoelectric elements PZ, which receives a predetermined driving waveform signal, shrinks and extends in the Z direction, thereby vibrating each region of the vibrating plate 27 in the Z direction. Upon the vibration of the vibrating plates 27 in the Z direction, the cavities 26 allows a part of the ink Ik contained therein to be discharged as liquid droplets D each having a predetermined weight.

Each of the liquid droplets D discharged lands in a position on the discharging surface SA of the substrate S1 facing the nozzle N, namely, in a targeted discharging position P. Then, the liquid droplet D that has landed in the targeted discharging position P is moved in the +Y direction by main scanning of the substrate S1.

The liquid droplet discharging heads 20 fixed onto the supporting plate 18 are arranged in a stepped layout in the +X and the +Y directions on an XY plane, as shown in FIG. 3. Specifically, between adjacent ones of the liquid droplet discharging heads 20, as viewed from the +Y direction, a first end of one of the heads in the +X direction overlaps with a second end of the other of the heads in the −X direction. Thereby, in the adjacent liquid droplet discharging heads 20, a gap between the nozzle lines adjacent is set to the nozzle pitch Dx, as viewed from the +Y direction. Each of the liquid droplet discharging heads 20 equalizes a resolution in the +X direction over an approximately entire width of the discharging surface SA in the +X direction. In FIG. 3, to show a layout of the discharging heads 20, a quantity of the nozzles N is restricted to 11.

As shown in FIG. 3, the discharging surface SA of the substrate S1 is virtually split into a dotted-lattice pattern, as indicated by single-dotted chain lines. In the dotted-lattice pattern, a lattice gap in the +Y direction and a lattice gap in the +X direction, respectively, are defined by a discharging pitch Dy of the liquid droplet D. The discharging pitch Dy in the +Y direction is determined by a discharging frequency of the liquid droplet D and a main scanning velocity (a conveying velocity Vs) of the substrate S1. Additionally, the discharging pitch in the +X direction is determined by the nozzle pitch Dx. A choice to determine whether the liquid droplet D is to be discharged or not is defined for each of lattice points T in the dotted-lattice pattern.

When discharging the liquid droplets D, a single group of the lattice points T arranged in the +Y direction is moved to pass immediately below a common single nozzle N by sub-scanning of the carriage 15 and main scanning of the substrate S1.

In the present embodiment, the lattice gap in the +Y direction, namely, the pitch between the liquid droplets D in the +Y direction is referred to as the discharging pitch Dy.

In FIG. 5, on a side of each discharging head 20 in the +X direction on the supporting plate 18, there is formed a rectangular emission hole 41 penetrating through the plate. Each emission hole 41 has a predetermined width in the +X direction. As shown in FIG. 5, on an upper side of the emission hole 41 is arranged a semiconductor laser LD as a laser beam outputting unit.

The semiconductor laser LD downward emits a belt-like collimated laser beam spreading over an entire width of the emission hole 41 in the +X direction. The laser beam emitted by the semiconductor laser LD has a wavelength range having a high absorptivity of moisture of the liquid droplet D (the ink Ik). In other words, the semiconductor laser LD emits a laser beam that dries the liquid droplet D by irradiation thereto.

Inside the emission hole 41 is arranged a cylindrical lens 42. When the semiconductor laser LD emits the laser beam, the cylindrical lens 42 converges only a component of the laser beam in the sub-scanning direction to downward emit as a belt-like beam Le.

The present embodiment uses the cylindrical lens 42. However, with the cylindrical lens 42, the beam has an intensity strong at a center of a nozzle-line direction and weak at opposite ends of the direction, which is a Gaussian beam. Thus, instead of the cylindrical lens 4, a diffractive optical element may be used such that beam intensity distribution forms a uniform belt-like beam.

As shown in FIG. 5, on a lower side of the emission hole 41 are arranged a pair of arms 43 extended below the supporting plate 18 and a reflecting mirror 44 rotatably supported between tip portions of the arms 43.

The reflecting mirror 44 is a planar mirror having a reflecting surface on a side of the mirror facing the cylindrical lens 42. Upon emission of the laser beam by the semiconductor laser LD, the reflecting mirror 44 reflects the belt-like beam Le from the cylindrical lens 42 in such a manner that the beam Le traverses immediately below each nozzle N in a space between the discharging surface SA and the nozzle-formed surface 23a, from the +X direction as viewed from the discharging head main body 22, namely, from the nozzle line direction.

The belt-like beam Le irradiated from the +X direction as viewed from the discharging head main body 22 toward the space (a platen gap) between the discharging surface SA and the nozzle-formed surface 23a has a width W1 shorter than the platen gap. Additionally, the beam Le has a thickness W2 (See FIGS. 3 and 4) larger than a diameter of the liquid droplet D to be discharged.

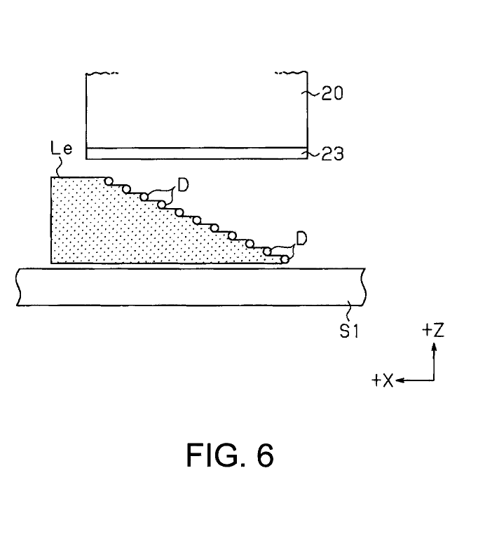

As shown in a schematic diagram of FIG. 6, for all nozzles N of the head 20, timings of discharging the liquid droplets D therefrom are set so as to ensure that each of the droplets D discharged from all the nozzles N is subjected to a continuous irradiation of the belt-like beam Le, without being intercepted by any other of the droplets D during a flight of each droplet in the platen gap.

Specifically, the liquid droplets D are not simultaneously discharged from all the nozzles N, but are discharged at timings different among the nozzles N. In the present embodiment, the discharging timing of the nozzle N is set earlier in positional order starting from the nozzle N closest to the reflecting mirror 44.

When a radius of the liquid droplet D is represented by “r” and a velocity of the droplet D is represented by “V”, a time difference Δt of discharging timing between a previously discharged droplet D and a subsequently discharged droplet D is expressed by a formula below:

Δt>2r/V

Satisfying the formula enables each droplet D discharged from each nozzle N to be subjected to a continuous irradiation of the beam Le, without being intercepted by any other of the droplets D. Accordingly, the present embodiment can ensure that a single belt-like laser beam (the beam Le) is irradiated to each of the droplets discharged from all the nozzles N.

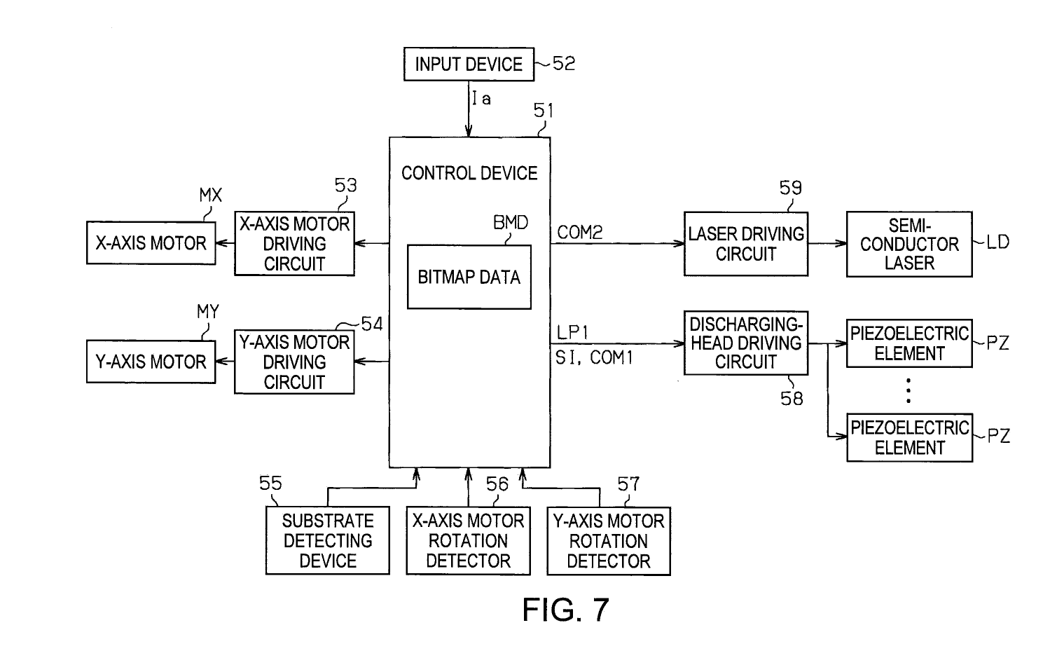

Next, an electrical structure of the liquid droplet discharging apparatus 10 structured as above will be described with reference to FIG. 7.

In FIG. 7, a control device 51 constituting a drive controlling unit includes a CPU, a RAM, and a ROM. The control device 51 moves the substrate stage 12 to drive the discharging head 20 (the piezoelectric element PZ) and the semiconductor laser LD, according to various data and various kinds of controlling programs stored in the ROM and the like.

The control device 51 is connected to an input device 52 with operating switches such as a starting switch and a stopping switch. The control device 51 receives a pattern image of a wiring formed on the substrate S1, as a drawing data Ia having a predetermined form. The control device 51 receives the drawing data Ia from the input device 52 to generate a bitmap data BMD, a piezoelectric-element driving voltage COM1, and a laser driving voltage COM2.

The bitmap data BMD defines a turn-on or a turn-off of the piezoelectric element PZ according to a value (0 or 1) of each bit. The BMD is data that defines whether the liquid droplet D is to be discharged or not in each position on the discharging surface SA of the substrate S1, namely, on a two-dimensional drawing plane. In this case, on the discharging surface SA of the substrate S1, a position where the liquid droplet D is placed is referred to as a droplet layout position.

The control device 51 is connected to an X-axis motor driving circuit 53 to output a drive control signal corresponding to the X-axis motor driving circuit 53. In response to the drive control signal from the control device 51, the X-axis motor driving circuit 53 rotates forwardly or reversely an X-axis motor that allows the carriage 15 to reciprocate in the sub-scanning direction. Additionally, the control device 51 is connected to a Y-axis motor driving circuit 54 to output a drive control signal corresponding to the Y-axis motor driving circuit 54. The Y-axis motor driving circuit 54 responds to the drive control signal from the control device 51 to rotate forwardly or reversely a Y-axis motor MY that allows the stage 12 to reciprocate in the main scanning direction.

The control device 51 is also connected to a substrate detecting device 55 capable of detecting an edge of the substrate S1 to calculate a position of the substrate S1 in a moment when the droplet layout position passes the targeted discharging position P immediately below the nozzle N, based on a detection signal from the substrate detecting device 55.

The control device 51 is also connected to an X-axis motor rotation detector 56 to receive a detection signal input from the X-axis motor rotation detector 56. Based on the detection signal from the X-axis motor rotation detector 56, the control device 51 calculates a moving direction and a moving amount of the liquid droplet discharging head 20 in the +X directions. Then, the control device 51 sets a droplet layout position corresponding to each nozzle N to on a conveying path of the targeted discharging position P, based on the moving direction and the movement amount calculated.

The control device 51 is also connected to a Y-axis motor rotation detector 57 to receive a detection signal from the Y-axis motor rotation detector 57. Based on the detection signal from the Y-axis motor rotation detector 57, the control device 51 calculates a moving direction and a moving amount of the stage 12 (the substrate S1) based on the detection signal from the Y-axis motor rotation detector 57.

Then, based on the moving direction and the moving amount calculated, the control device 51 obtains a timing at which a center of each droplet layout position comes to the targeted discharging position P immediately below the nozzle N to output a driving timing signal LP1 to a discharging-head driving circuit 58 at the obtained timing.

The control device is connected to the discharging-head driving circuit 58 included in the drive controlling unit. The control device 51 synchronizes the piezoelectric-element driving voltage COM1 with a predetermined clock signal to output to the discharging-head driving circuit 58. The control device 51 generates a discharging control signal SI in synch with a predetermined reference clock signal based on the bitmap data BMD to serially transfer the signal SI to the discharging-head driving circuit 58. The discharging-head driving circuit 58 sequentially performs serial-to-parallel conversion of the discharging control signal S1 from the control device 51 in a manner corresponding to the piezoelectric element PZ of each nozzle N.

The discharging-head driving circuit 58 receives the driving timing signal LP1 from the control device 51 to supply the piezoelectric-element driving voltage COM1 to the piezoelectric element PZ selected based on the discharging control signal S1.

In this situation, the discharging-head driving circuit 58 makes different a supplying timing of the piezoelectric-element driving voltage COM1 supplied to each selected piezoelectric element PZ. Specifically, the piezoelectric-element driving voltage COM1 is supplied to each piezoelectric element PZ, in the time difference Δt, in positional order starting from the piezoelectric element PZ of the nozzle N closest to the reflecting mirror 44.

Thus, the liquid droplet D discharged from each selected nozzle N is subjected to a continuous irradiation of the beam Le, without allowing the beam Le to be intercepted by any other of the droplets D.

The control device 51 is also connected to a laser driving circuit 59. The control device 51 outputs the laser driving voltage COM2 to the laser driving circuit 59. The laser driving circuit 59 outputs the laser driving voltage COM2 input from the control device 51 to the semiconductor laser LD to drive the laser LD. In the embodiment, the control device 51 always outputs the laser driving voltage COM2 to the laser driving circuit 59 while conveying the substrate S1 in the +Y and the −Y directions.

In the structure as above, the control device 51 and the discharging-head driving circuit 58 convey the substrate S1 mounted on the stage 12 in the +Y direction to discharge the liquid droplets D on the discharging surface SA of the substrate S1 so as to form a wiring pattern. In this case, the piezoelectric-element driving voltage COM1 is supplied to each selected piezoelectric element PZ in the time difference Δt, sequentially in the order starting from the piezoelectric element PZ of the nozzle N closest to the reflecting mirror 44.

As a result, the droplet D discharged from each selected nozzle N lands on the substrate S1 while being subjected to a continuous irradiation of the beam Le, without allowing the beam Le to be intercepted by any other of the droplets D.

Next, advantages of the first embodiment structured as above will be described below.

(1) In the first embodiment, the beam Le having a belt-like shape elongated in the Z direction is applied from the +X direction as viewed from the liquid droplet discharging head 20 in such a manner that the beam traverses immediately below each nozzle N in the space between the discharging surface SA and the nozzle-formed surface 23a.

In that manner, an entire part from one end to the other end of the beam Le like a belt long in the Z direction can be efficiently applied to the liquid droplet D. Consequently, the liquid droplet D can be dried in an air, with a high energy efficiency of the laser beam.

(2) In the embodiment, the timings of discharging the liquid droplets D from the nozzles N are made different from each other so as to allow the liquid droplet D from each nozzle N to be subjected to a continuous irradiation of the beam Le, while preventing the beam Le toward any one of the droplets from being intercepted by any other of the droplets D. Accordingly, the embodiment can ensure that the single belt-like laser beam (the beam Le) is applied to all the droplets D from the respective nozzles N.

(3) In the embodiment, the thickness W2 of the belt-like beam Le is only a little longer than a thickness completely covering the droplet D (a diameter of the liquid droplet D). Thus, the belt-like beam Le can be generated by using a low-cost optical device.

### Second Embodiment

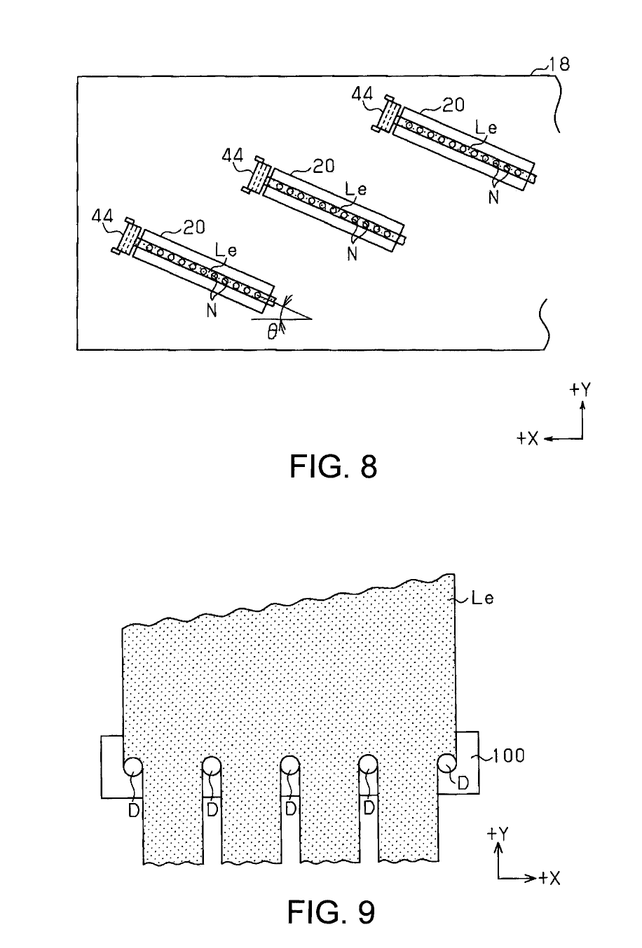

Next, a second embodiment of the invention will be described with reference to FIG. 8. In the second embodiment, the layout of the liquid droplet discharging heads 20 provided on the supporting plate 18 is different from that of the heads 20 in the first embodiment. Thus, for descriptive convenience, parts different from the first embodiment will be described in detail.

FIG. 8 illustrates the layout of the liquid droplet discharging heads 20 according to the second embodiment appeared as viewed from the stage 12. Each head 20 has 11 nozzles N as in the first embodiment, for descriptive convenience.

The liquid droplet discharging heads 20 fixed on the supporting plate 18 are each inclined by an inclined angle θwith respect to the +X direction on the XY plane. Specifically, the nozzle line of each head 20 is inclined by the inclined angle θ.

Additionally, the beam Le traversing immediately below each nozzle N of the liquid droplet discharging head 20 is also inclined by the inclined angle θ with respect to the +X direction to be applied to the space between the substrate S1 and the nozzle plate 23.

The inclined angle θ is set as follows:

In the first embodiment, the timings of discharging the liquid droplets D from the respective nozzles N are made different from each other. Specifically, each nozzle is allowed to discharge the liquid droplet D at the discharging timing of the time difference Δt, sequentially in the order starting from the nozzle N closest to the reflecting mirror 44.

Accordingly, when the radius of the droplet D is r, the velocity of the droplet D is V, and the time difference of discharging timings between the droplet D and a following droplet D is Δt, a discharging time difference Tx between the liquid droplet D of a nozzle N discharging earliest and the liquid droplet of an eleventh nozzle N discharging latest is expressed by a formula below:

Tx=11×Δt=11(2r/V)

Regarding the time difference Δt, when the velocity Vs for conveying the substrate S1 (the stage 12) is extremely slow, it is possible to ignore a landing deviation, in the +Y direction, of the liquid droplet D discharged from each nozzle N.

However, when increasing the conveying velocity Vs to improve production efficiency, the landing deviation cannot be ignored any longer. Thus, in order to eliminate the landing deviation of the droplet D from each nozzle N in the +Y direction, the discharging head 20 is inclined by the inclined angle θ.

In a case of adjacent droplets D that have landed on the substrate S1, when the landing deviation of each of the adjacent droplets D in the +Y direction is Δy and the conveying velocity is Vs, the deviation Δy is obtained by a formula below:

Δy=Vs×Δt

Then, when a gap between the respective nozzles N spaced apart at an equal pitch is Dx (See FIG. 3), the angle θ of the head 20 inclined to correct the landing deviation Δy is obtained by a formula below:

θ=tan⁻¹(Δy/Dx)=tan⁻¹(Vs×Δt/Dx)

Allowing the discharging head 20 to be inclined at the inclined angle θ obtained based on the above formula can prevent the landing of the droplet D from each nozzle N from deviating in the +Y direction.

Consequently, the above embodiment enables formation of a highly precise pattern while improving production efficiency.

Additionally, the above embodiments may be altered, for example, as below.

In the embodiments, the semiconductor laser LD is continuously driven. Alternatively, the semiconductor laser LD may be driven at the timings of discharging the liquid droplets D from the respective nozzles N of the discharging head 20. During a time in which the discharging head 20 is not discharging the liquid droplets D, the semiconductor laser LD can be stopped. This results in reduction of electricity consumption.

Furthermore, in the above embodiments, the nozzles N formed in the nozzle plate 23 of the discharging head 20 forms the signal nozzle line. Instead of that, the discharging head 20 may have a plurality of nozzle lines. In this case, each beam Le may be applied to each nozzle line, or a single beam Le may be applied to the droplets D of each nozzle line.

Furthermore, the liquid droplet discharging apparatus of the above embodiments draws a wiring pattern on the substrate S1 (such as a green sheet, a glass substrate, a silicon substrate, a ceramic substrate, a resin film, or paper). However, the invention is not restricted to that and is applicable to various kinds of liquid droplet discharging apparatuses such as those forming an insulating layer, a color filter, or an alignment film, for example.

Furthermore, in the embodiments, the liquid droplet discharging unit is embodied as the liquid droplet discharging head 20 using a piezoelectric element driving system. Other than that, for example, the discharging unit may be embodied as a discharging head using a resistance heating system or an electrostatic driving system.

The entire disclosure of Japanese Patent Application No. 2007-265273, filed Oct. 11, 2007 is expressly incorporated by reference herein.

What is claimed is:

1. A liquid droplet drying method of a liquid droplet discharging apparatus, comprising:
discharging liquid droplets from respective nozzles of a discharging head onto a substrate, the droplets being discharged from the nozzles at timings different from each other; and
drying the liquid droplets by irradiating a laser beam to the liquid droplets vertically to a discharging direction of the liquid droplets while the droplets are flying toward the substrate, the laser beam being irradiated in a layout direction of the nozzles of the discharging head.

2. The liquid droplet drying method of a liquid droplet discharging apparatus, according to claim 1, wherein, among the liquid droplets sequentially discharged from the nozzles, a time difference of discharging timing between a previously discharged droplet and a subsequent droplet is expressed by a formula: Δt>2r/V, in which Δt represents the time difference, r represents a radius of the droplet, and V represents a velocity of the droplet.

3. The liquid droplet drying method of a liquid droplet discharging apparatus, according to claim 2, wherein an inclined angle of the layout direction of the nozzles of the discharging head with respect to a sub-scanning direction orthogonal to a main scanning direction is expressed by a formula: θ=tan⁻¹(Δy/Dx)=tan⁻¹(Vs×Δt/Dx), in which θ represents the inclined angle; Dx represents a gap between the nozzles; and Vs represents a conveying velocity of the substrate.

4. A liquid droplet discharging apparatus, comprising:
a substrate;
a discharging head that discharges liquid droplets to the substrate;
a nozzle plate with nozzles that is included in the discharging head; and
a laser beam outputting unit that irradiates a laser beam to the liquid droplets while the droplets are flying toward the substrate so as to dry the droplets, the laser beam outputting unit being provided on a first side in a layout direction of the nozzles of the head to irradiate the laser beam traversing immediately below the nozzles from the layout direction of the nozzles, between the nozzle plate of the head and the substrate.

5. The liquid droplet discharging apparatus according to claim 4, further including a drive controlling unit that drive-controls the discharging head to make different the discharging timings of the droplets discharged from the respective nozzles so as to allow the laser beam toward a droplet discharged from any one of the nozzles not to be intercepted by a droplet discharged from any other of the nozzles located in an irradiating direction of the laser beam.

6. The liquid droplet discharging apparatus according to claim 5, wherein, among the liquid droplets sequentially discharged from the nozzles, a time difference of discharging timing between a previously discharged droplet and a subsequent droplet is expressed by a formula: Δt>2r/V, in which Δt represents the time difference; r represents a radius of the droplet; and V represents a velocity of the droplet, and wherein the drive controlling unit drive-controls the discharging head to discharge the droplets from the respective nozzles in the time difference Δt.

7. The liquid droplet discharging apparatus according to claim 5, wherein the discharging head is laid out in such a manner that an inclined angle of the layout direction of the nozzles of the discharging head with respect to a sub-scanning direction orthogonal to a main scanning direction is expressed by a formula: θ=tan⁻¹(Δy/Dx)=tan⁻¹(Vs×Δt/Dx), in which θ represents the inclined angle; Dx represents a gap between the nozzles; and Vs represents a conveying velocity of the substrate.
